(19) United States
(12) Patent Application Publication
(10) Pub. No.: US 2026/0328959 A1
(43) Pub. Date: Oct. 22, 2026

(54) MULTIPLE-WAVE MIGRATION IMAGING METHOD AND APPARATUS BASED ON ITERATIVE DECONVOLUTION IMAGING CONDITION

(71) Applicants: China National Petroleum Corporation, Beijing (CN); BGP Inc., China National Petroleum Corporation, Hebei (CN); CNPC Exploration Software Co., Ltd., Beijing (CN)

(72) Inventors: Jianlu WU, Hebei (CN); Yu ZHANG, Hebei (CN); Feng CHEN, Hebei (CN); Lian DUAN, Hebei (CN); Kunlun YANG, Hebei (CN); Jiawen SONG, Hebei (CN)

(21) Appl. No.: 19/491,084

(22) PCT Filed: Jan. 3, 2024
(86) PCT No.: PCT/CN2024/070288

§ 371 Date: Dec. 8, 2025

(30) Foreign Application Priority Data
Jun. 8, 2023 (CN) 202310678905.3

(51) Int. Cl. G01V 1/36; G01V 1/28

(52) U.S. Cl. CPC G01V 1/36; G01V 1/282; G01V 2210/51

(57) ABSTRACT

Provided are a multiple-wave migration imaging method and apparatus based on an iterative deconvolution imaging condition. The method includes: obtaining a seismic wave forward-propagated wavefield and a seismic wave reverse wavefield; performing multiple-wave imaging on the seismic wave forward-propagated wavefield and seismic wave backward-propagated wavefield using a deconvolution imaging condition, to obtain an initial imaging result; taking the seismic wave forward-propagated wavefield, the seismic wave backward-propagated wavefield and the initial imaging result as inputs, and performing multiple-wave imaging using an iterative deconvolution imaging method, to obtain an iterative deconvolution multiple-wave imaging result; determining a deconvolution imaging objective function value during the multiple-wave imaging; and if the deconvolution imaging objective function value does not meet a preset condition, iterating the imaging result until the deconvolution imaging objective function value meets the preset condition and generating a final iterative deconvolution multiple-wave imaging result based on an imaging result obtained after iteration.

### RELATED APPLICATION

The present application claims the priority of the Chinese Patent Application No. 202310678905.3, and filed on Jun. 8, 2023, which is hereby incorporated by reference in its entirety.

### TECHNICAL FIELD

The present disclosure relates to the technical field of seismic data imaging and migration in geophysical exploration for petroleum, and particularly to a multiple-wave migration imaging method and apparatus based on an iterative deconvolution imaging condition.

### BACKGROUND ART

This section is intended to provide background or context for the embodiments of the present disclosure set forth in the claims. The description herein is not admitted to be the prior art just because it is included in this section.

In the conventional marine exploration seismic processing, the free-surface multiple-wave signals are generally removed as interference information. However, the information of underground medium parameters contained in the free-surface multiple-wave signals is not fully utilized and excavated, which is a difficult problem and bottleneck in the seismic processing and imaging at present. Therefore, a free-surface based multiple-wave imaging method can make full use of free-surface multiple-wave information to perform seismic migration for both shallow and deep subsurface media, realize high-precision imaging of the seabed and its vicinity, and solve the problem of insufficient imaging range of the shallow layers in the conventional imaging methods.

Berkhout and Verschuur (1994) proposed a free-surface multiple-wave migration based on the frameworks of upgoing and downgoing wavefields. Subsequently, Schuster and Rickett (2000) converted multiple waves into primary waves through the interference principle and carried out migration in accordance with the conventional imaging frameworks, and Shan (2003) improved this pseudo-primary wave imaging theory and applied it to actual production. Lu et al. (2021) systematically studied and improved such methods and applied them to industrial processing procedures. Multiple-wave imaging can be realized under the frameworks of a one-way wave equation and a wave equation. Due to the existence of multi-order multiple-wave information in the conventional multiple-wave inversion methods, multiple-wave signals of different orders are imaged mutually, resulting in interferences and reduction of the imaging quality, which is also an important issue leading to difficulties in industrial applications.

At present, the methods for suppressing crosstalk in a multiple-wave imaging process may be classified as follows. A first method is to suppress crosstalk using a deconvolution imaging condition. This method is relatively simple to implement, but it can only be used as an approximate method to eliminate the impact of crosstalk, and can only suppress or eliminate most of the crosstalk. A second method is to image multiple waves of different orders during imaging to avoid imaging crosstalk caused by different orders. However, this method cannot avoid crosstalk caused by multiple-wave signals of the same order and requires additional separation of multiple-wave signals of different orders from seismic data. A third method is a multiple-wave imaging method based on a migration algorithm, the core of which is to use the migration algorithm to estimate and then eliminate crosstalk events, but this method requires adaptive subtraction processing and requires the separation of primary waves and multiple waves. A fourth method is a least-square multiple-wave imaging method, which can perfectly solve the problem of imaging crosstalk and may be implemented by means of the one-way wave equation and the wave equation. However, the computational cost of this method may increase by several orders of magnitude and it has a great impact on the noise in the data.

At present, the industrial application of the multiple-wave imaging mainly adopts a multiple-wave migration method based on a deconvolution imaging condition, and imaging data results have low definition and poor imaging effect. Therefore, there is an urgent need for a technical solution that can overcome the above defects and improve the imaging effect.

### SUMMARY OF THE DISCLOSURE

To address the problems existing in the prior art, the present disclosure proposes a multiple-wave migration imaging method and apparatus based on an iterative deconvolution imaging condition. Different from the multiple-wave imaging based on the conventional deconvolution imaging condition, the present disclosure introduces regularization terms in frequency and spatial domains, so that the multiple-wave imaging result is clearer with a wider frequency range.

In a first aspect of the embodiments of the present disclosure, there is provided a multiple-wave migration imaging method based on an iterative deconvolution imaging condition, including:
obtaining a seismic wave forward-propagated wavefield and a seismic wave backward-propagated wavefield;
performing multi-wave imaging on the seismic wave forward-propagated wavefield and the seismic wave backward-propagated wavefield using a deconvolution imaging condition, to obtain an initial imaging result;
taking the seismic wave forward-propagated wavefield, the seismic wave backward-propagated wavefield and the initial imaging result as inputs, and performing multiple-wave imaging using an iterative deconvolution imaging method, to obtain an iterative deconvolution multiple-wave imaging result;
determining a deconvolution imaging objective function value during the multi-wave imaging; and
if the deconvolution imaging objective function value does not meet a preset condition, iterating the imaging result until the deconvolution imaging objective function value meets the preset condition, and generating a final iterative deconvolution multiple-wave imaging result based on an imaging result obtained after iteration.

In the multiple-wave migration imaging method based on the iterative deconvolution imaging condition according to the embodiments of the present disclosure, the obtaining a seismic wave forward-propagated wavefield includes:
obtaining input data, which is seismic full-wavefield shot record data containing direct waves, primary reflected waves and free-surface multiple-wave information, during a forward propagation; and
simulating a forward propagation of wavefield using a one-way wave equation according to the input data, to obtain a seismic wave forward-propagated wavefield.

In the multiple-wave migration imaging method based on the iterative deconvolution imaging condition according to the embodiments of the present disclosure, the obtaining a seismic wave backward-propagated wavefield includes:
obtaining input data, which is multiple-wave information or seismic full-wavefield shot record data, during a backward propagation; and
simulating a backward propagation of wavefield using a one-way wave equation according to the input data, to obtain a seismic wave backward-propagated wavefield.

In the multiple-wave migration imaging method based on the iterative deconvolution imaging condition according to the embodiments of the present disclosure, the determining a deconvolution imaging objective function value during the multi-wave imaging includes using:
a relational expression of a deconvolution imaging objective function:

$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ;$$

where E(R) denotes an objective function value;
U denotes a seismic wave backward-propagated wavefield;
D denotes a seismic wave forward-propagated wavefield;
R denotes an imaging result;
ΔR means calculating a spatial derivative of the imaging result;
a and β are dimensionless parameters;
ω denotes a circular frequency; and

$$\frac{\partial R}{\partial ω}$$

means calculating a frequency derivative of the imaging result.

In the multiple-wave migration imaging method based on the iterative deconvolution imaging condition according to the embodiments of the present disclosure, if the deconvolution imaging objective function value does not meet a preset condition, the iterating the imaging result until the deconvolution imaging objective function value meets the preset condition, and generating a final iterative deconvolution multiple-wave imaging result based on an imaging result obtained after iteration includes using:
a formula of the iterative deconvolution imaging condition:

$${R}_{i , j , k , l}^{n + 1} = \frac{{U}_{i , j , k , l} {\overline{D}}_{i , j , k , l} + α ( {R}_{i + 1 j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ;$$

where Rⁿ⁺¹ denotes an imaging result after an (n+1)-th iteration;
Rⁿ denotes an imaging result after an n-th iteration;
i, j, k and l denote spatial and frequency coordinates (x, y, z, ω) of the imaging result;
D̅ denotes a complex conjugate of the seismic wave forward-propagated wavefield.

In the multiple-wave migration imaging method based on the iterative deconvolution imaging condition according to the embodiments of the present disclosure, if the deconvolution imaging objective function value does not meet a preset condition, the iterating the imaging result until the deconvolution imaging objective function value meets the preset condition, and generating a final iterative deconvolution multiple-wave imaging result based on an imaging result obtained after iteration includes:
recalculating the objective function value according to an imaging result Rⁿ⁺¹ after iteration, wherein the objective function value gradually approaches 0 during calculation; and
when the deconvolution imaging objective function value meets a preset condition, generate a final iterative deconvolution multiple-wave imaging result according to the imaging result after iteration.

In a second aspect of the embodiments of the present disclosure, there is provided a multiple-wave migration imaging apparatus based on an iterative deconvolution imaging condition, including:
a data obtaining module configured to obtain a seismic wave forward-propagated wavefield and a seismic wave backward-propagated wavefield; and
a multiple-wave imaging processing module configured to perform multi-wave imaging on the seismic wave forward-propagated wavefield and the seismic wave backward-propagated wavefield using a deconvolution imaging condition, to obtain an initial imaging result;
take the seismic wave forward-propagated wavefield, the seismic wave backward-propagated wavefield and the initial imaging result as inputs, and perform multiple-wave imaging using an iterative deconvolution imaging method, to obtain an iterative deconvolution multiple-wave imaging result;
determine a deconvolution imaging objective function value during the multi-wave imaging; and
if the deconvolution imaging objective function value does not meet a preset condition, iterate the imaging result until the deconvolution imaging objective function value meets the preset condition, and generate a final iterative deconvolution multiple-wave imaging result based on an imaging result obtained after iteration.

In the multiple-wave migration imaging apparatus based on the iterative deconvolution imaging condition according to the embodiments of the present disclosure, the data obtaining module is specifically configured to:
obtain input data, which is seismic full-wavefield shot record data containing direct waves, primary reflected waves and free-surface multiple-wave information, during a forward propagation; and
simulate a forward propagation of wavefield using a one-way wave equation according to the input data, to obtain a seismic wave forward-propagated wavefield.

In the multiple-wave migration imaging apparatus based on the iterative deconvolution imaging condition according to the embodiments of the present disclosure, the data obtaining module is specifically configured to:
obtain input data, which is multiple-wave information or seismic full-wavefield shot record data, during a backward propagation; and
simulate a wavefield backward propagation using a one-way wave equation according to the input data, to obtain a seismic wave backward-propagated wavefield.

In the multiple-wave migration imaging apparatus based on the iterative deconvolution imaging condition according to the embodiments of the present disclosure, the multiple-wave imaging processing module is configured to determine a deconvolution imaging objective function value during the multi-wave imaging, including using:
a relational expression of a deconvolution imaging objective function:

$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ;$$

where E(R) denotes an objective function value;
U denotes a seismic wave backward-propagated wavefield;
D denotes a seismic wave forward-propagated wavefield;
R denotes an imaging result;
ΔR means calculating a spatial derivative of the imaging result;
a and β are dimensionless parameters;
ω denotes a circular frequency; and

$$\frac{\partial R}{\partial ω}$$

means calculating a frequency derivative of the imaging result.

In the multiple-wave migration imaging apparatus based on the iterative deconvolution imaging condition according to the embodiments of the present disclosure, if the deconvolution imaging objective function value does not meet a preset condition, the multiple-wave imaging processing module is configured to iterate the imaging result until the deconvolution imaging objective function value meets the preset condition, and generates a final iterative deconvolution multiple-wave imaging result based on an imaging result obtained after iteration, including using:
a formula of the iterative deconvolution imaging condition:

$${R}_{i , j , k , l}^{n + 1} = \frac{{U}_{i , j , k , l} {\overline{D}}_{i , j , k , l} + α ( {R}_{i + 1 j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ;$$

where Rⁿ⁺¹ denotes an imaging result after an (n+1)-th iteration;
Rⁿ denotes an imaging result after an n-th iteration;
i, j, k and 1 denote spatial and frequency coordinates (x, y, z, ω) of the imaging result;
D̅ denotes a complex conjugate of the seismic wave forward-propagated wavefield.

In the multiple-wave migration imaging apparatus based on the iterative deconvolution imaging condition according to the embodiments of the present disclosure, the multiple-wave imaging processing module is specifically configured to:
recalculate the objective function value according to an imaging result Rⁿ⁺¹ after iteration, wherein the objective function value gradually approaches 0 during calculation; and
when the deconvolution imaging objective function value meets a preset condition, generate a final iterative deconvolution multiple-wave imaging result based on the imaging result after iteration.

In a third aspect of the embodiments of the present disclosure, there is provided a computer device, including a memory, a processor, and a computer program stored in the memory and runnable in the processor, in which when executing the computer program, the processor implements the multiple-wave migration imaging method based on the iterative deconvolution imaging condition.

In a fourth aspect of the embodiments of the present disclosure, there is provided a computer-readable storage medium storing a computer program which, when executed by a processor, implements the multiple-wave migration imaging method based on the iterative deconvolution imaging condition.

In a fifth aspect of the embodiments of the present disclosure, there is provided a computer program product, including a computer program which, when executed by a processor, implements the multiple-wave migration imaging method based on the iterative deconvolution imaging condition.

During implementation of the multiple-wave migration imaging method and apparatus based on the iterative deconvolution imaging condition proposed by the present disclosure, the iterative deconvolution imaging condition has constraints in both spatial and frequency domains for imaging, thereby achieving a higher flexibility in imaging control. The iterative deconvolution imaging condition is an extension of the conventional deconvolution imaging method, and the physical basis is more complete. The iterative deconvolution imaging condition can broaden the frequency range of the imaging result, thereby achieving a better imaging resolution, and providing strong technical support for petroleum exploration.

### BRIEF DESCRIPTION OF THE DRAWINGS

In order to explain the technical solutions of the embodiments of the present disclosure more clearly, the drawings to be used in the description of the embodiments may be briefly introduced below. Obviously, the drawings involved in the following description only illustrate some embodiments of the present disclosure, and other drawings can be obtained by those of ordinary skill in the art from these drawings without creative work.

FIG. 1 illustrates a flowchart of a multiple-wave migration imaging method based on an iterative deconvolution imaging condition according to an embodiment of the present disclosure.

FIG. 2 illustrates a flowchart of multiple-wave imaging based on an iterative deconvolution condition according to a specific embodiment of the present disclosure.

FIG. 3A illustrates a schematic diagram of full-wavefield seismic records of a single-layer model according to a specific embodiment of the present disclosure.

FIG. 3B illustrates a schematic diagram of multiple-wave records according to a specific embodiment of the present disclosure.

FIG. 4A illustrates a schematic diagram of multiple-wave migration results based on a cross-correlation imaging condition according to a specific embodiment of the present disclosure.

FIG. 4B illustrates a partially enlarged view of FIG. 4A.

FIG. 4C illustrates a schematic diagram of multiple-wave migration results based on a conventional deconvolution imaging condition according to a specific embodiment of the present disclosure.

FIG. 4D illustrates a partially enlarged view of FIG. 4C.

FIG. 4E illustrates a schematic diagram of multiple-wave migration results based on an iterative deconvolution imaging condition according to a specific embodiment of the present disclosure.

FIG. 4F illustrates a partially enlarged view of FIG. 4E.

FIG. 5 illustrates a schematic diagram of spectrum comparison under cross-correlation, conventional deconvolution, and iterative deconvolution imaging conditions according to a specific embodiment of the present disclosure.

FIG. 6 illustrates a schematic diagram of VSP collection and observation using a Marmousi model according to a specific embodiment of the present disclosure.

FIG. 7A illustrates a schematic diagram of seismic records at a receiver depth of 200 m according to a specific embodiment of the present disclosure.

FIG. 7B illustrates a schematic diagram of seismic records at a receiver depth of 1700 m according to a specific embodiment of the present disclosure.

FIG. 7C illustrates a schematic diagram of seismic records of at a receiver depth of 3200 m according to a specific embodiment of the present disclosure.

FIG. 8A illustrates a schematic diagram of conventional deconvolution migration results according to a specific embodiment of the present disclosure.

FIG. 8B illustrates a schematic diagram of iterative deconvolution migration results according to a specific embodiment of the present disclosure.

FIG. 9 illustrates a schematic diagram of an architecture of a multiple-wave migration imaging apparatus based on an iterative deconvolution imaging condition according to an embodiment of the present disclosure.

FIG. 10 illustrates a schematic diagram of a structure of a computer device according to an embodiment of the present disclosure.

### DETAILED DESCRIPTION OF THE EMBODIMENTS

The principle and the spirit of the present disclosure may be described below with reference to several exemplary embodiments. It should be understood that the embodiments are given only to enable those skilled in the art to better understand and then realize the present disclosure, and are not intended to limit the scope of the present disclosure in any way. Rather, these embodiments are provided so that the present disclosure can be more thorough and complete, and the scope of the present disclosure can be fully conveyed to those skilled in the art.

As known to those skilled in the art, the embodiments of the present disclosure may be implemented as a system, apparatus, device, method or computer program product. Therefore, the present disclosure may be specifically embodied as complete hardware, complete software (including firmware, resident software, microcode, etc.), or a combination of hardware and software.

According to the embodiments of the present disclosure, there is provided a multiple-wave migration imaging method and apparatus based on an iterative deconvolution imaging condition, which relate to the technical field of seismic data imaging and migration in geophysical exploration for petroleum. The present disclosure proposes a regularization constraint objective function of spatial and frequency domain constraints, and provides an iterative solution method, enabling during multiple-wave migration, the frequency bandwidth of migration imaging can be improved as much as possible to improve the imaging quality.

The principle and the spirit of the present disclosure may be explained in detail with reference to several representative embodiments of the present disclosure.

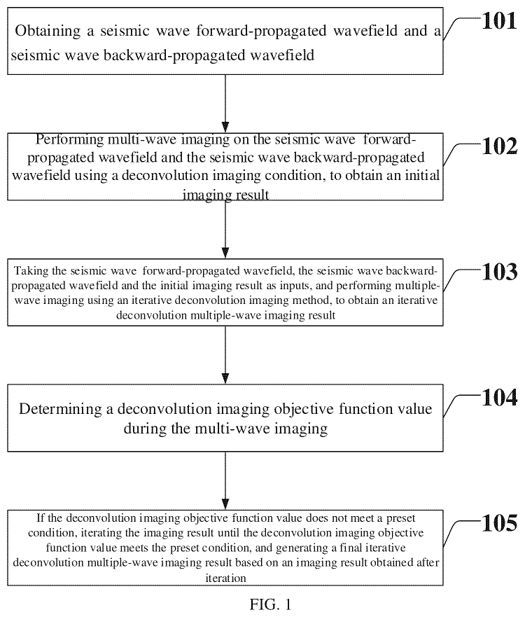

FIG. 1 illustrates a flowchart of a multiple-wave migration imaging method based on an iterative deconvolution imaging condition according to an embodiment of the present disclosure. As illustrated in FIG. 1, the method includes:
Step 101: obtaining a seismic wave forward-propagated wavefield and a seismic wave backward-propagated wavefield;
Step 102: performing multi-wave imaging on the seismic wave forward-propagated wavefield and the seismic wave backward-propagated wavefield using a deconvolution imaging condition, to obtain an initial imaging result;
Step 103: taking the seismic wave forward-propagated wavefield, the seismic wave backward-propagated wavefield and the initial imaging result as inputs, and performing multiple-wave imaging using an iterative deconvolution imaging method, to obtain an iterative deconvolution multiple-wave imaging result;
Step 104: determining a deconvolution imaging objective function value during the multiple-wave imaging; and
Step 105: if the deconvolution imaging objective function value does not meet a preset condition, iterating the imaging result until the deconvolution imaging objective function value meets the preset condition, and generating a final iterative deconvolution multiple-wave imaging result based on an imaging result obtained after iteration.

In practical application scenarios, the working principle of the multiple-wave migration imaging method based on the iterative deconvolution imaging condition is as follows: obtaining a seismic wave forward-propagated wavefield and a seismic wave backward-propagated wavefield; performing multiple-wave imaging on the seismic wave forward-propagated wavefield and the seismic wave backward-propagated wavefield using a deconvolution imaging condition, to obtain an initial imaging result; taking the seismic wave forward-propagated wavefield, the seismic wave backward-propagated wavefield and the initial imaging result as inputs, and performing multiple-wave imaging using an iterative deconvolution imaging method, to obtain an iterative deconvolution multiple-wave imaging result; determining a deconvolution imaging objective function value during the multiple-wave imaging; and if the deconvolution imaging objective function value does not meet a preset condition, iterating the imaging result until the deconvolution imaging objective function value meets the preset condition, and generating a final iterative deconvolution multiple-wave imaging result based on an imaging result obtained after iteration. The present disclosure proposes a regularization constraint objective function of spatial and frequency domain constraints, and gives an iterative solution method, so that during multiple-wave migration, the frequency bandwidth of migration imaging can be broadened as much as possible to improve the imaging quality.

To explain the above multiple-wave migration imaging method based on the iterative deconvolution imaging condition more clearly, each step may be described in detail below.

In an embodiment, in step 101, the obtaining a seismic wave forward-propagated wavefield includes:
obtaining input data, which is seismic full-wavefield shot record data containing direct waves, primary reflected waves and free-surface multiple-wave information, during a forward-propagated; and
simulating a wavefield forward-propagated using a one-way wave equation according to the input data, to obtain a seismic wave forward-propagated wavefield.

A seismic wave forward-propagated wavelength may be denoted by D.

In an embodiment, in step 101, the obtaining a seismic wave backward-propagated wavefield includes:
obtaining input data, which is multiple-wave information or seismic full-wavefield shot record data, during a backward-propagated; and
simulating a wavefield backward-propagated using a one-way wave equation according to the input data, to obtain a seismic wave forward-propagated wavefield.

A seismic wave backward-propagated wavelength may be denoted by U.

In an embodiment, in step 102, multi-wave imaging is performed on the seismic wave forward-propagated wavefield and the seismic wave backward-propagated wavefield using a deconvolution imaging condition, to obtain an initial imaging result R⁰.

In an embodiment, in step 103, the seismic wave forward-propagated wavefield, the seismic wave backward-propagated wavefield and the initial imaging result R⁰ are taken as inputs, and multiple-wave imaging is performed using an iterative deconvolution imaging method, to obtain an iterative deconvolution multiple-wave imaging result.

In an embodiment, in step 104, the determining a deconvolution imaging objective function value during the multi-wave imaging includes:
a relational expression of a deconvolution imaging objective function:

$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ;$$

where E(R) denotes an objective function value;
U denotes a seismic wave backward-propagated wavefield;
D denotes a seismic wave forward-propagated wavefield;
R denotes an imaging result;
ΔR means calculating a spatial derivative of the imaging result;
a and β are dimensionless parameters;
ω denotes a circular frequency; and

$$\frac{\partial R}{\partial ω}$$

means calculating a frequency derivative of the imaging result.

In an embodiment, in step 105, if the deconvolution imaging objective function value does not meet a preset condition, the iterating the imaging result until the deconvolution imaging objective function value meets the preset condition, and generating a final iterative deconvolution multiple-wave imaging result based on an imaging result obtained after iteration, by using:
a formula of the iterative deconvolution imaging condition:

$${R}_{i , j , k , l}^{n + 1} = \frac{{U}_{i , j , k , l} {\overline{D}}_{i , j , k , l} + α ( {R}_{i + 1 j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ;$$

where Rⁿ⁺¹ denotes an imaging result after an (n+1)-th iteration;
Rⁿ denotes an imaging result after an n-th iteration;
i, j, k and 1 denote spatial and frequency coordinates (x, y, z, ω) of the imaging result; i, j and k correspond to a space x, y, z, and 1 corresponds to a frequency ω);
D̅ denotes a complex conjugate of the seismic wave forward-propagated wavefield.

The objective function value is recalculated according to an imaging result Rⁿ⁺¹ after iteration, in which the objective function value gradually approaches 0 during calculation; and
when the deconvolution imaging objective function value meets a preset condition, a final iterative deconvolution multiple-wave imaging result is generated based on the imaging result after iteration.

To explain the multiple-wave migration imaging method based on the iterative deconvolution imaging condition more clearly, a detailed description may be given below in conjunction with a specific embodiment.

In the scenario of the prior art, the objective function E(R) to be solved for the multiple-wave migration based on the conventional deconvolution imaging condition is:

$$E ( R ) = {min}_{R} \frac{1}{2} {‖ U - RD ‖}_{2}^{2} + \frac{λ}{2} {‖ R ‖}_{2}^{2} ; \qquad ( 1 )$$

the multiple-wave imaging based on the conventional deconvolution imaging condition is to solve the Formula (1) to derive the following specific imaging formula:

$$R ( \vec{x} ) = {\sum }_{ω} \frac{\overline{D} U}{‖ D {‖}^{2} + λ} ; \qquad ( 2 )$$

where R(\vec{x}) denotes an imaging result.

The industrial application of the existing multiple-wave imaging mainly adopts the multiple-wave migration method based on the deconvolution imaging condition. Different from the multiple-wave imaging based on the conventional deconvolution imaging condition, the present disclosure introduces regularization terms in frequency and spatial domains, so that the multiple-wave imaging result is clearer with a wider frequency range. Specifically, compared with the objective function based on the conventional deconvolution imaging condition, the present disclosure proposes a new deconvolution imaging objective function:

$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ; \qquad ( 3 )$$

Formula (3) cannot separate the imaging results using the conventional gradient-based solution. It is necessary to adopt an optical flow method to solve the objective function, and the calculation method is:

$${R}_{i , j , k , l}^{n + 1} = \frac{{U}_{i , j , k , l} {\overline{D}}_{i , j , k , l} + α ( {R}_{i + 1 , j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ; \qquad ( 4 )$$

Formula (4) is a formula for the iterative deconvolution imaging condition, and is used to iteratively solve the imaging results to achieve the iterative deconvolution multiple-wave imaging.

The multiple-wave migration imaging method based on the iterative deconvolution imaging condition proposed in the present disclosure has at least the following advantages compared with the prior art:
1. The iterative deconvolution imaging condition has constraints in both spatial and frequency domains of the imaging, thereby achieving a higher flexibility in imaging control.
2. The iterative deconvolution imaging condition is an extension of the conventional deconvolution imaging method, and the physical basis is more complete.
3. The iterative deconvolution imaging condition can expand the frequency range of the imaging result, thereby achieving a better imaging resolution.

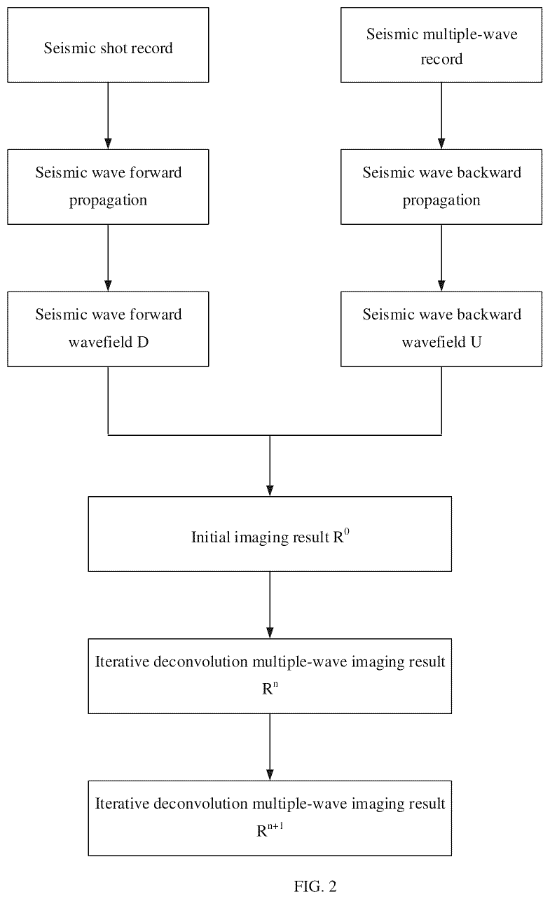

From the perspective of a practical scenario, reference is made to FIG. 2, which illustrates a flowchart of multiple-wave imaging based on an iterative deconvolution condition according to a specific embodiment of the present disclosure. As illustrated in FIG. 2, firstly, seismic shot records are input; input data for forward propagation is seismic full-wavefield shot record data containing direct waves, primary reflected waves, and free-surface multiple-wave information; input data for backward propagation may be either only multiple-wave information or seismic full-wavefield shot records.

Subsequently, based on the input shot records, a one-way wave equation algorithm is adopted to perform forward and backward propagations of the wavefield, to obtain a forward-propagated wavefield D and a backward-propagated wavefield U. The conventional deconvolution imaging condition is adopted to perform multiple-wave imaging on the forward-propagated wavefield and the backward-propagated wavefield, thereby calculating an imaging result R⁰.

Next, the wavefields U and D and the initial imaging result R⁰ are taken as inputs, and the iterative deconvolution imaging formula is adopted to perform multiple-wave imaging, thereby obtaining an iterative deconvolution multiple-wave imaging result Rⁿ after n iterations, and an iterative deconvolution multiple-wave imaging result Rⁿ⁺¹ after n+1 iterations.

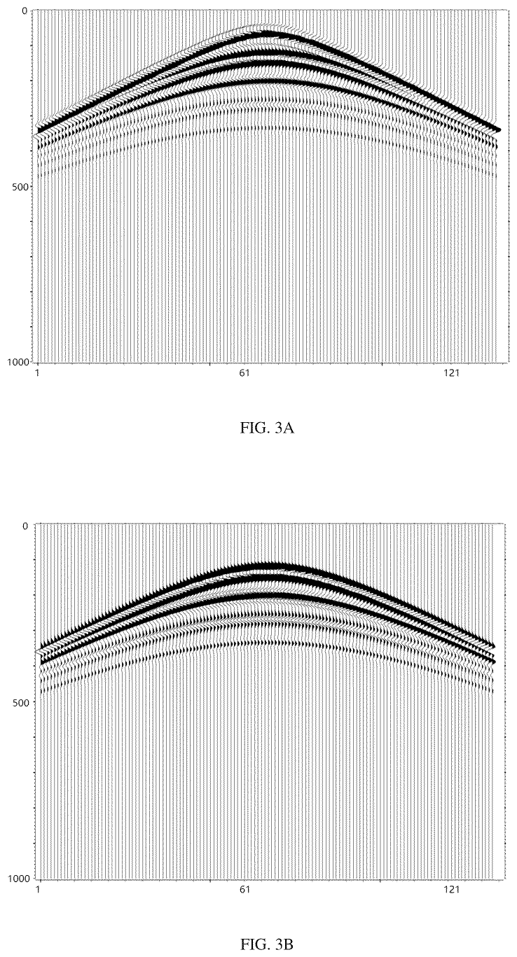

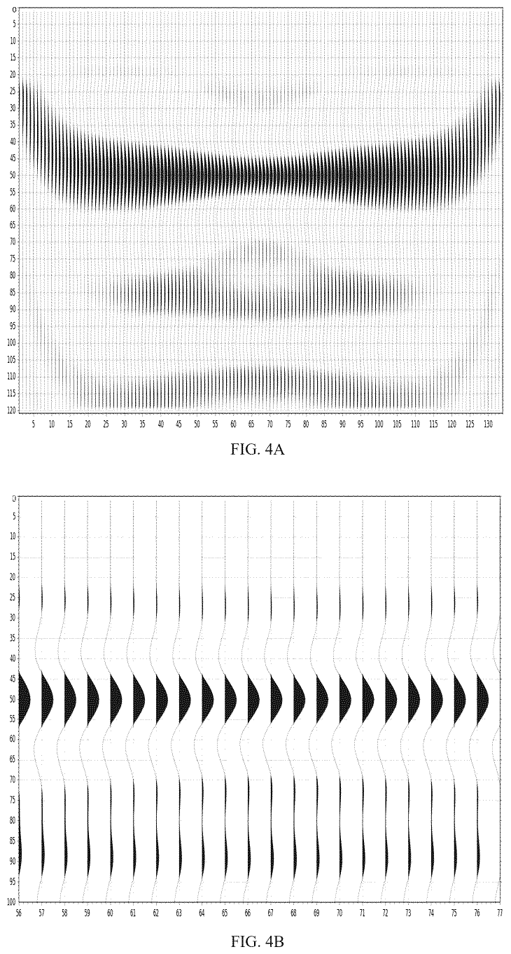

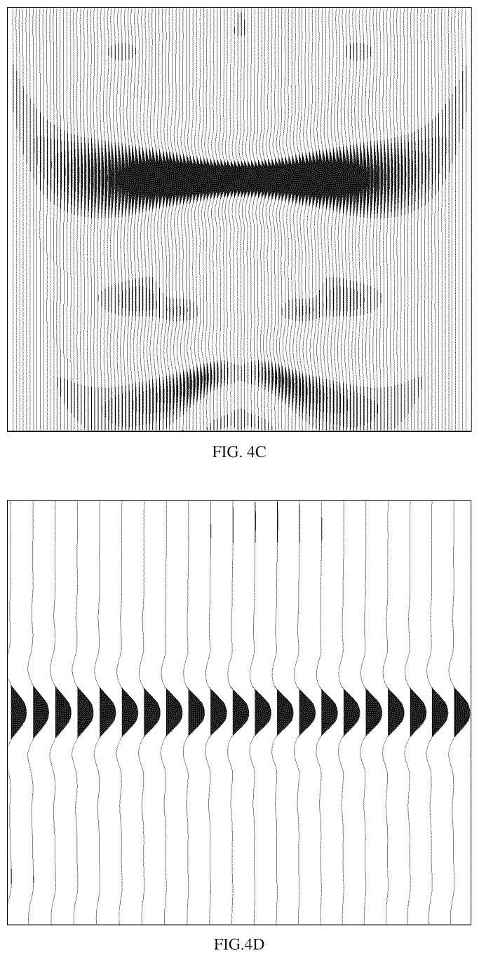

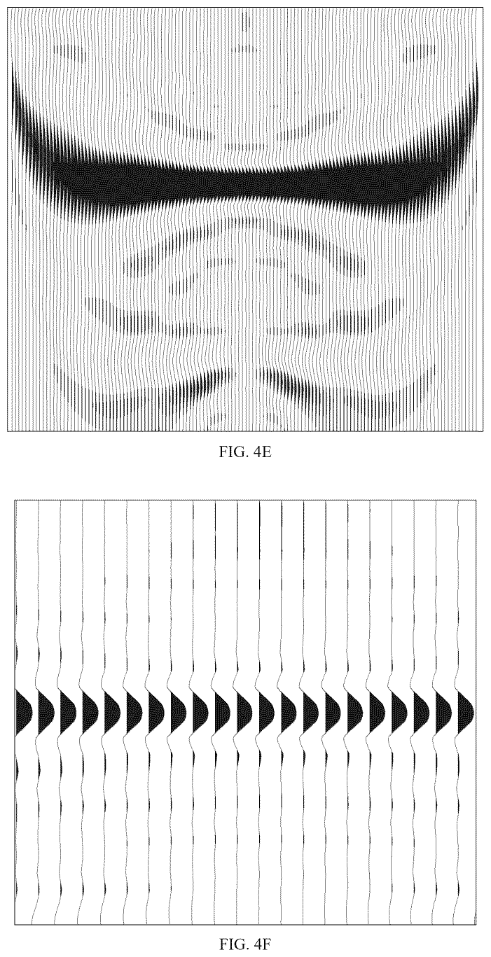

To verify the effectiveness of the method, the full-wavefield seismic records (FIG. 3A) and the multiple-wave records (FIG. 3B) of a single-layer model are used as inputs for calculations. The multiple-wave imaging is performed based on a cross-correlation imaging condition, a conventional deconvolution imaging condition, and an iterative deconvolution imaging condition. The calculation results are illustrated in FIGS. 4A to 4F, in which FIGS. 4A, 4C and 4E have horizontal coordinate ranges of 0 to 135, and vertical coordinate ranges of 0 to 123; and the corresponding partially enlarged views (FIGS. 4B, 4D and 4F) have horizontal coordinate ranges of 56 to 77 and vertical coordinate ranges of 0 to 100.

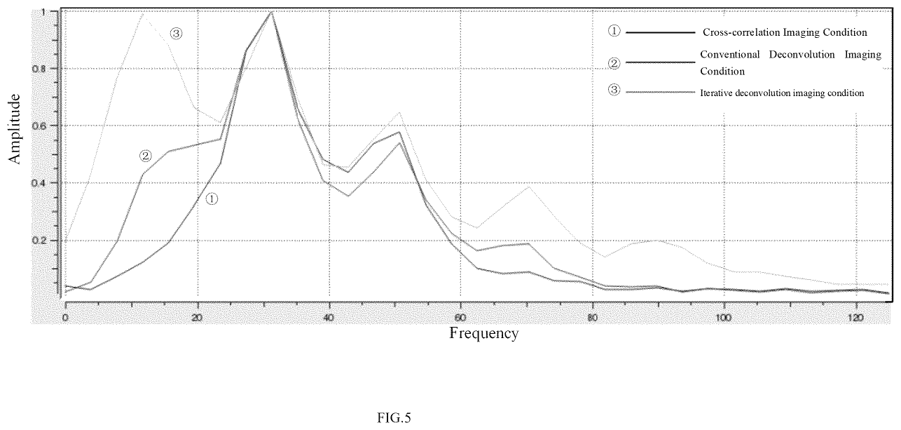

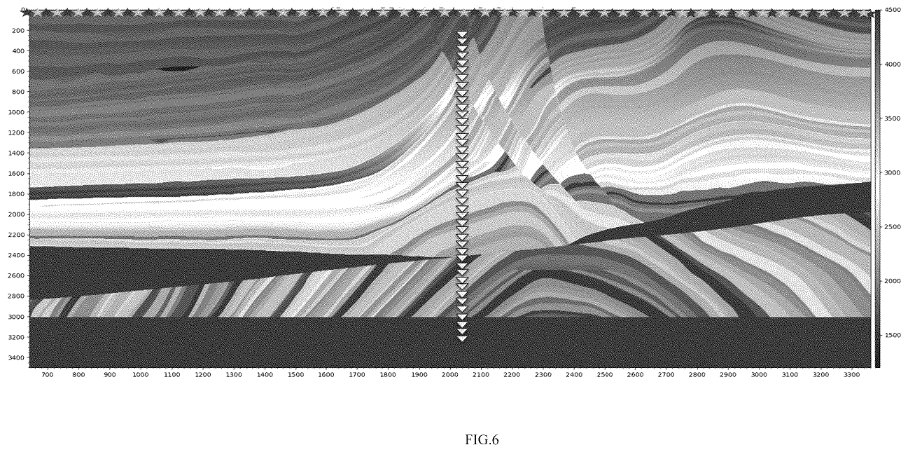

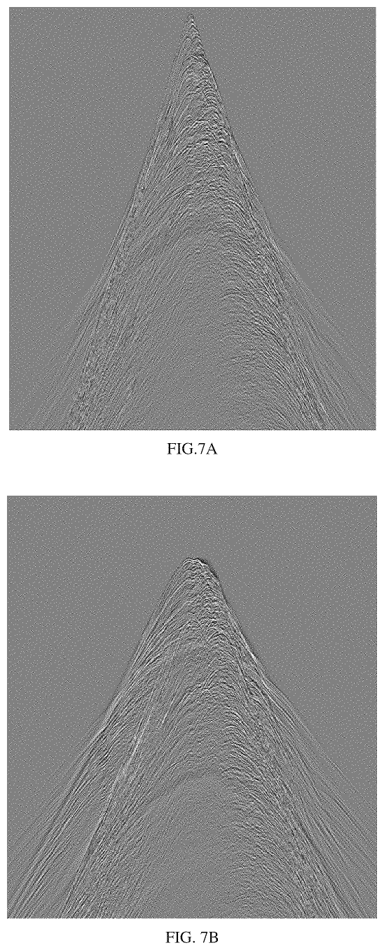

The spectra of the three results are further compared, as illustrated in FIG. 5. As can be seen from FIG. 5, the iterative deconvolution imaging result has a widest spectrum and a highest resolution, which proves the effectiveness of the method. To further verify the stability of the method, a Marmousi model is used for VSP seismic collection, as illustrated in FIG. 6. Due to the relative complexity of the Marmousi model, relatively complex common detection point (CDP) gathers are received at different depths, as illustrated in FIGS. 7A to 7C.

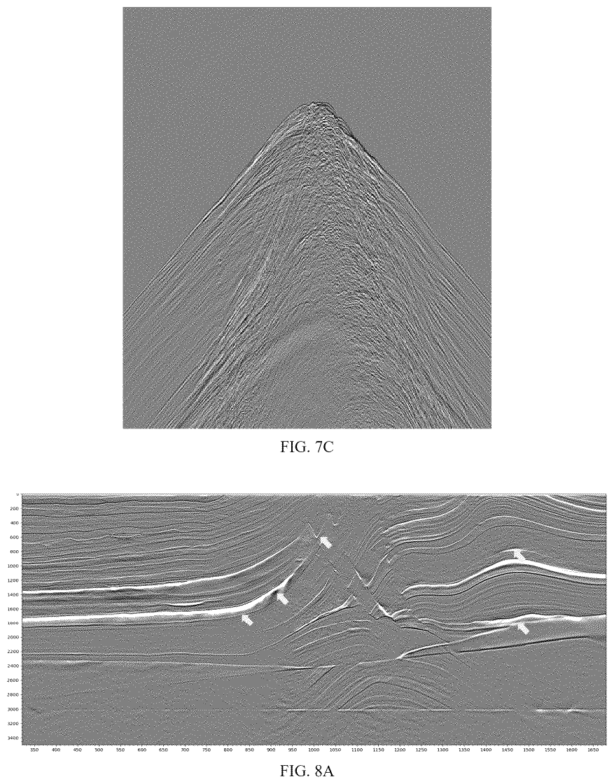

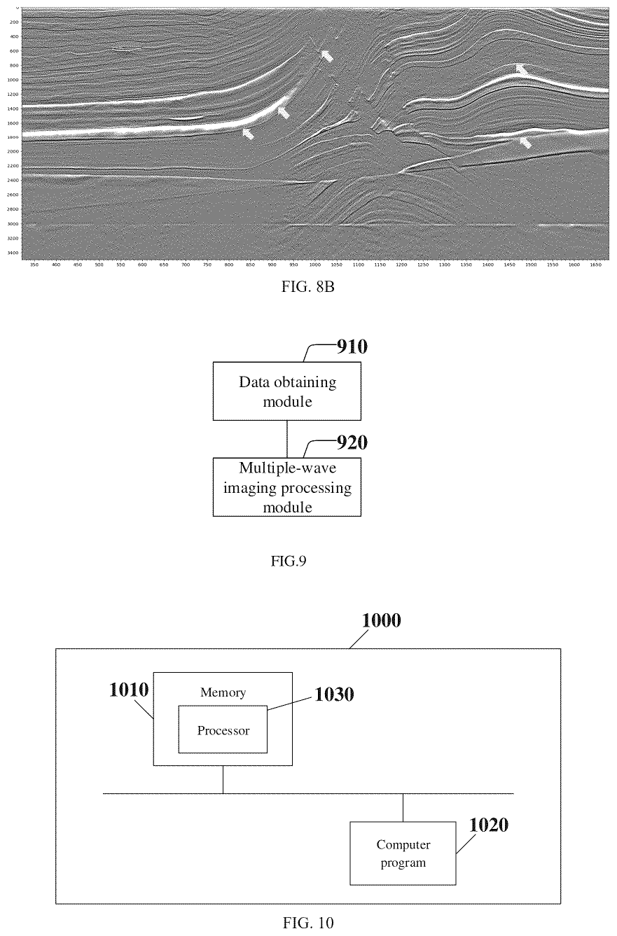

Finally, conventional deconvolution imaging and iterative deconvolution imaging are used to achieve multiple-wave migration, and the results are illustrated in FIGS. 8A and 8B. Through comparison, it can be seen that the resolution and the lateral continuity of the iterative deconvolution imaging results have been significantly improved, which proves the advantages and effectiveness of the method proposed in the present disclosure.

It should be noted that although the operations of the method of the present disclosure are described in a specific order in the above embodiments and drawings, it is not required or implied that these operations must be performed in the specific order, or that the desired results only when all the operations illustrated are performed. Additionally or alternatively, some steps may be omitted, a plurality of steps may be combined into one step for execution, and/or one step may be divided into a plurality of steps for execution.

After introducing the method according to the exemplary embodiments of the present disclosure, a multi-wave migration imaging apparatus based on an iterative deconvolution imaging condition according to the exemplary embodiments of the present disclosure is introduced below with reference to FIG. 9.

For the implementations of the multiple-wave migration imaging apparatus based on the iterative deconvolution imaging condition, please refer to the implementations of the above method, and the repeated content will be omitted. The term “module” or “unit” used below may be a combination of software and/or hardware for realizing a predetermined function. Although the apparatus described in the following embodiments is exemplarily implemented with software, the implementation with hardware, or a combination of software and hardware, is also possible and contemplated.

Based on the same inventive concept, the present disclosure further proposes a multiple-wave migration imaging apparatus based on an iterative deconvolution imaging condition, as illustrated in FIG. 9, which includes:
a data obtaining module 910 configured to obtain a seismic wave forward-propagated wavefield and a seismic wave backward-propagated wavefield; and
a multiple-wave imaging processing module 920 configured to perform multi-wave imaging on the seismic wave forward-propagated wavefield and the seismic wave backward-propagated wavefield using a deconvolution imaging condition, to obtain an initial imaging result;
take the seismic wave forward-propagated wavefield, the seismic wave backward-propagated wavefield and the initial imaging result as inputs, and perform multiple-wave imaging using an iterative deconvolution imaging method, to obtain an iterative deconvolution multiple-wave imaging result;
determine a deconvolution imaging objective function value during the multi-wave imaging; and
when the deconvolution imaging objective function value does not meet a preset condition, iteratively update the imaging result until the deconvolution imaging objective function value meets the preset condition, and generate a final iterative deconvolution multiple-wave imaging result based on the iteratively updated imaging result.

In an embodiment, the data obtaining module 910 is specifically configured to:
obtain input data, which is seismic full-wavefield shot record data containing direct waves, primary reflected waves and free-surface multiple-wave information, during a forward-propagated; and
simulate a wavefield forward-propagated using a one-way wave equation according to the input data, to obtain a seismic wave forward-propagated wavefield.

In an embodiment, the data obtaining module 910 is specifically configured to:
obtain input data, which is multiple-wave information or seismic full-wavefield shot record data, during a backward propagation; and
simulate a wavefield backward propagation using a one-way wave equation according to the input data, to obtain a seismic wave backward-propagated wavefield.

In an embodiment, the multiple-wave imaging processing module 920 is configured to determine a deconvolution imaging objective function value during the multi-wave imaging, by using:
a relational expression of a deconvolution imaging objective function:

$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ;$$

where E(R) denotes an objective function value;
U denotes a seismic wave backward-propagated wavefield;
D denotes a seismic wave forward-propagated wavefield;
R denotes an imaging result;
∇R means calculating a spatial derivative of the imaging result;
a and β are dimensionless parameters;
ω denotes a circular frequency; and

$$\frac{\partial R}{\partial ω}$$

means calculating a frequency derivative of the imaging result.

In an embodiment, if the deconvolution imaging objective function value does not meet a preset condition, the multiple-wave imaging processing module 920 is configured to iterate the imaging result until the deconvolution imaging objective function value meets the preset condition, and generates a final iterative deconvolution multiple-wave imaging result according to an imaging result obtained after iteration, by using:
a formula of the iterative deconvolution imaging condition:

$${R}_{i , j , k , l}^{n + 1} = \frac{{U}_{i , j , k , l} {\overline{D}}_{i , j , k , l} + α ( {R}_{i + 1 , j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ;$$

where Rⁿ⁺¹ denotes an imaging result after an (n+1)-th iteration;
Rⁿ denotes an imaging result after an n-th iteration;
i, j, k and l denote spatial and frequency coordinates (x, y, z, ω) of the imaging result;
D̅ denotes a complex conjugate of the seismic wave forward-propagated wavefield.

In an embodiment, the multiple-wave imaging processing module 920 is specifically configured to:
recalculate the objective function value based on an imaging result Rⁿ⁺¹ after iteration, wherein the objective function value gradually approaches 0 during calculation; and
when the deconvolution imaging objective function value meets a preset condition, generate a final iterative deconvolution multiple-wave imaging result based on the imaging result after iteration.

It should be noted that although several modules of the multiple-wave migration imaging apparatus based on the iterative deconvolution imaging condition are mentioned in the above detailed description, such division is only exemplary and not mandatory. In fact, according to the embodiments of the present disclosure, the features and functions of two or more modules described above may be embodied in one module. On the contrary, the features and functions of one module described above may be further divided to be embodied by a plurality of modules.

Based on the afore-mentioned inventive concept, as illustrated in FIG. 10, the present disclosure further proposes a computer device 1000, which includes a memory 1010, a processor 1020, and a computer program 1030 stored in the memory 1010 and runnable in the processor 1020, wherein when executing the computer program 1030, the processor 1020 implements the afore-mentioned multi-wave migration imaging method based on the iterative deconvolution imaging condition.

Based on the afore-mentioned inventive concept, the present disclosure further proposes a computer-readable storage medium storing a computer program which, when executed by a processor, implements the afore-mentioned multiple-wave migration imaging method based on the iterative deconvolution imaging condition.

Based on the afore-mentioned inventive concept, the present disclosure further proposes a computer program product including a computer program which, when executed by a processor, implements the afore-mentioned multiple-wave migration imaging method based on the iterative deconvolution imaging condition.

During implementation of the multiple-wave migration imaging method and apparatus based on the iterative deconvolution imaging condition proposed by the present disclosure, the iterative deconvolution imaging condition has constraints in both spatial and frequency domains for imaging, thereby achieving a higher flexibility in imaging control. The iterative deconvolution imaging condition is an extension of the conventional deconvolution imaging method, and the physical basis is more complete. The iterative deconvolution imaging condition can broaden the frequency range of the imaging result, thereby achieving a better imaging resolution, and providing strong technical support for petroleum exploration.

The obtaining, storage, use and processing of the data in the technical solutions of the present disclosure comply with the relevant provisions of laws and regulations.

Those skilled in the art should appreciate that any embodiment of the present disclosure can be provided as a method, an apparatus or a computer program product. Therefore, the present disclosure can take the form of a full hardware embodiment, a full software embodiment, or an embodiment combining software and hardware. Moreover, the present invention can take the form of a computer program product implemented on one or more computer usable storage mediums (including, but not limited to, a magnetic disc memory, CD-ROM, optical storage, etc.) containing therein computer usable program codes.

The present disclosure is described with reference to the flowcharts and/or block diagrams of the method, apparatus and computer program product according to the embodiments of the present disclosure. It shall be appreciated that each flow and/or block in the flowchart and/or block diagram, and the combinations of the flows and/or blocks in the flowchart and/or block diagram can be implemented through computer program instructions. The computer program instructions may be provided to a general computer, a dedicated computer, an embedded processor or a processor of other programmable data processing device, to form a machine so that the instructions, which are executed through the computer or the processor of other programmable data processing device, generate means for realizing the functions specified in one or more flows in the flowchart and one or more blocks in the block diagram.

These computer program instructions may also be stored in a computer readable memory capable of directing the computer or other programmable data processing devices to operate in a specific manner, such that the instructions stored in the computer readable memory generate a manufactured article including an instruction device that implements the function(s) designated in one flow or a plurality of flows in the flowchart and/or a block or a plurality of blocks in the block diagram.

These computer program instructions may also be loaded onto a computer or other programmable data processing devices, such that a series of operation steps is executed on the computer or other programmable devices to generate the processing realized by the computer, therefore the instructions executed on the computer or other programmable devices provide the steps for implementing the function designated in one flow or a plurality of flows in the flow chart and/or a block or a plurality of blocks in the block diagram.

Finally, it should be noted that those described above are only specific embodiments of the present disclosure, which are used to illustrate, rather than limiting, the technical solutions of the present disclosure, and the protection scope of the present disclosure is not limited thereto. Although the present disclosure has been described in detail with reference to the above embodiments, those of ordinary skill in the art should understand that within the technical scope revealed in the present disclosure, any person familiar with the technical field can still modify or easily conceive of changes to the technical solutions in the above embodiments, or equivalently replace some of the technical features. These modifications, changes or replacements do not cause the essences of the corresponding technical solutions to deviate from the spirit and the scope of the technical solutions of the embodiments of the present disclosure, and should be included in the protection scope of the present disclosure. Therefore, the protection scope of the present disclosure should be subject to the protection scope of the appended claims.

What is claimed is:

1. A multiple-wave migration imaging method based on an iterative deconvolution imaging condition, comprising:
obtaining a seismic wave forward-propagated wavefield and a seismic wave backward-propagated wavefield;
performing multi-wave imaging on the seismic wave forward-propagated wavefield and the seismic wave backward-propagated wavefield using a deconvolution imaging condition, to obtain an initial imaging result;
taking the seismic wave forward-propagated wavefield, the seismic wave backward-propagated wavefield and the initial imaging result as inputs, and performing multiple-wave imaging using an iterative deconvolution imaging method, to obtain an iterative deconvolution multiple-wave imaging result;
determining a deconvolution imaging objective function value during the multi-wave imaging; and
if the deconvolution imaging objective function value does not meet a preset condition, iterating the imaging result until the deconvolution imaging objective function value meets the preset condition, and generating a final iterative deconvolution multiple-wave imaging result based on an imaging result obtained after iteration.

2. The multiple-wave migration imaging method based on the iterative deconvolution imaging condition according to claim 1, wherein the obtaining a seismic wave forward-propagated wavefield comprises:
obtaining input data, which is seismic full-wavefield shot record data comprising direct waves, primary reflected waves and free-surface multiple-wave information, during a forward propagation; and
simulating a forward propagation of wavefield using a one-way wave equation according to the input data, to obtain a seismic wave forward-propagated wavefield.

3. The multiple-wave migration imaging method based on the iterative deconvolution imaging condition according to claim 1, wherein the obtaining a seismic wave backward-propagated wavefield comprises:
obtaining input data, which is multiple-wave information or seismic full-wavefield shot record data, during a backward propagation; and
simulating a backward propagation of wavefield using a one-way wave equation according to the input data, to obtain a seismic wave backward-propagated wavefield.

4. The multiple-wave migration imaging method based on the iterative deconvolution imaging condition according to claim 1, wherein the determining a deconvolution imaging objective function value during the multi-wave imaging comprises using:
a relational expression of a deconvolution imaging objective function:
$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ;$$
where E(R) denotes an objective function value;
U denotes a seismic wave backward-propagated wavefield;
D denotes a seismic wave forward-propagated wavefield;
R denotes an imaging result;
∇R means calculating a spatial derivative of the imaging result;
a and β are dimensionless parameters;
ω denotes a circular frequency; and
$$\frac{\partial R}{\partial ω}$$
means calculating a frequency derivative of the imaging result.

5. The multiple-wave migration imaging method based on the iterative deconvolution imaging condition according to claim 4, wherein if the deconvolution imaging objective function value does not meet a preset condition, the iterating the imaging result until the deconvolution imaging objective function value meets the preset condition, and generating a final iterative deconvolution multiple-wave imaging result based on an imaging result obtained after iteration comprises using:
a formula of the iterative deconvolution imaging condition:
$${R}_{i , j , k , l}^{n + 1} = \frac{{U}_{i , j , k , l} {\overline{D}}_{i , j , k , l} + α ( {R}_{i + 1 , j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ;$$
where Rⁿ⁺¹ denotes an imaging result after an (n+1)-th iteration;
Rⁿ denotes an imaging result after an n-th iteration;
i, j, k and l denote spatial and frequency coordinates (x, y, z, ω) of the imaging result;
D̅ denotes a complex conjugate of the seismic wave forward-propagated wavefield.

6. The multiple-wave migration imaging method based on the iterative deconvolution imaging condition according to claim 5, wherein if the deconvolution imaging objective function value does not meet a preset condition, the iterating the imaging result until the deconvolution imaging objective function value meets the preset condition, and generating a final iterative deconvolution multiple-wave imaging result based on an imaging result obtained after iteration comprises:
recalculating the objective function value according to an imaging result Rⁿ⁺¹ after iteration, wherein the objective function value gradually approaches 0 during calculation; and
when the deconvolution imaging objective function value meets a preset condition, generate a final iterative deconvolution multiple-wave imaging result according to the imaging result after iteration.

7. A multiple-wave migration imaging apparatus based on an iterative deconvolution imaging condition, comprising:
a data obtaining module configured to obtain a seismic wave forward-propagated wavefield and a seismic wave backward-propagated wavefield; and
a multiple-wave imaging processing module configured to perform multi-wave imaging on the seismic wave forward-propagated wavefield and the seismic wave backward-propagated wavefield using a deconvolution imaging condition, to obtain an initial imaging result;
take the seismic wave forward-propagated wavefield, the seismic wave backward-propagated wavefield and the initial imaging result as inputs, and perform multiple-wave imaging using an iterative deconvolution imaging method, to obtain an iterative deconvolution multiple-wave imaging result;
determine a deconvolution imaging objective function value during the multi-wave imaging; and
if the deconvolution imaging objective function value does not meet a preset condition, iterate the imaging result until the deconvolution imaging objective function value meets the preset condition, and generate a final iterative deconvolution multiple-wave imaging result based on an imaging result obtained after iteration.

8. The multiple-wave migration imaging apparatus based on the iterative deconvolution imaging condition according to claim 7, wherein the data obtaining module is specifically configured to:
obtain input data, which is seismic full-wavefield shot record data comprising direct waves, primary reflected waves and free-surface multiple-wave information, during a forward propagation; and
simulate a forward propagation of wavefield using a one-way wave equation according to the input data, to obtain a seismic wave forward-propagated wavefield.

9. The multiple-wave migration imaging apparatus based on the iterative deconvolution imaging condition according to claim 7, wherein the data obtaining module is specifically configured to:
obtain input data, which is multiple-wave information or seismic full-wavefield shot record data, during a backward propagation; and
simulate a wavefield backward propagation using a one-way wave equation according to the input data, to obtain a seismic wave backward-propagated wavefield.

10. The multiple-wave migration imaging apparatus based on the iterative deconvolution imaging condition according to claim 7, wherein the multiple-wave imaging processing module is configured to determine a deconvolution imaging objective function value during the multi-wave imaging, comprising using:
a relational expression of a deconvolution imaging objective function:
$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ;$$
where E(R) denotes an objective function value;
U denotes a seismic wave backward-propagated wavefield;
D denotes a seismic wave forward-propagated wavefield;
R denotes an imaging result;
∇R means calculating a spatial derivative of the imaging result;
a and β are dimensionless parameters;
ω denotes a circular frequency; and
$$\frac{\partial R}{\partial ω}$$
means calculating a frequency derivative of the imaging result.

11. The multiple-wave migration imaging apparatus based on the iterative deconvolution imaging condition according to claim 10, wherein if the deconvolution imaging objective function value does not meet a preset condition, the multiple-wave imaging processing module is configured to iterate the imaging result until the deconvolution imaging objective function value meets the preset condition, and generates a final iterative deconvolution multiple-wave imaging result based on an imaging result obtained after iteration, comprising using:
a formula of the iterative deconvolution imaging condition:
$${R}_{i , j , k , l}^{n + 1} = \frac{{U}_{i , j , k , l} {\overline{D}}_{i , j , k , l} + α ( {R}_{i + 1 , j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ;$$
where Rⁿ⁺¹ denotes an imaging result after an (n+1)-th iteration;
Rⁿ denotes an imaging result after an n-th iteration;
i, j, k and l denote spatial and frequency coordinates (x, y, z, ω) of the imaging result;
D̅ denotes a complex conjugate of the seismic wave forward-propagated wavefield.

12. The multiple-wave migration imaging apparatus based on the iterative deconvolution imaging condition according to claim 11, wherein the multiple-wave imaging processing module is specifically configured to:
recalculate the objective function value according to an imaging result Rⁿ⁺¹ after iteration, wherein the objective function value gradually approaches 0 during calculation; and
when the deconvolution imaging objective function value meets a preset condition, generate a final iterative deconvolution multiple-wave imaging result based on the imaging result after iteration.

13. A computer device, comprising a memory, a processor, and a computer program stored in the memory and runnable in the processor, wherein when executing the computer program, the processor implements a method based on an iterative deconvolution imaging condition, comprising:
obtaining a seismic wave forward-propagated wavefield and a seismic wave backward-propagated wavefield;
performing multi-wave imaging on the seismic wave forward-propagated wavefield and the seismic wave backward-propagated wavefield using a deconvolution imaging condition, to obtain an initial imaging result;
taking the seismic wave forward-propagated wavefield, the seismic wave backward-propagated wavefield and the initial imaging result as inputs, and performing multiple-wave imaging using an iterative deconvolution imaging method, to obtain an iterative deconvolution multiple-wave imaging result;
determining a deconvolution imaging objective function value during the multi-wave imaging; and
if the deconvolution imaging objective function value does not meet a preset condition, iterating the imaging result until the deconvolution imaging objective function value meets the preset condition, and generating a final iterative deconvolution multiple-wave imaging result based on an imaging result obtained after iteration.

14-15. (canceled)

16. The computer device according to the claim 13, wherein the obtaining a seismic wave forward-propagated wavefield comprises:
obtaining input data, which is seismic full-wavefield shot record data comprising direct waves, primary reflected waves and free-surface multiple-wave information, during a forward propagation; and
simulating a forward propagation of wavefield using a one-way wave equation according to the input data, to obtain a seismic wave forward-propagated wavefield.

17. The multiple-wave migration imaging method based on the iterative deconvolution imaging condition according to claim 13, wherein the obtaining a seismic wave backward-propagated wavefield comprises:
obtaining input data, which is multiple-wave information or seismic full-wavefield shot record data, during a backward propagation; and
simulating a backward propagation of wavefield using a one-way wave equation according to the input data, to obtain a seismic wave backward-propagated wavefield.

18. The multiple-wave migration imaging method based on the iterative deconvolution imaging condition according to claim 1, wherein the determining a deconvolution imaging objective function value during the multi-wave imaging comprises using:
a relational expression of a deconvolution imaging objective function:
$$E ( R ) = {min}_{R} \frac{1}{2} {‖ U - RD ‖}_{2}^{2} + \frac{a}{2} {‖ ∇ R ‖}_{2}^{2} + \frac{β}{2} {‖ \frac{\partial R}{\partial ω} ‖}_{2}^{2} ;$$
where E(R) denotes an objective function value;
U denotes a seismic wave backward-propagated wavefield;
D denotes a seismic wave forward-propagated wavefield;
R denotes an imaging result;
∇R means calculating a spatial derivative of the imaging result;
a and β are dimensionless parameters;
ω denotes a circular frequency; and
$$\frac{\partial R}{\partial ω}$$
means calculating a frequency derivative of the imaging result.

19. The multiple-wave migration imaging method based on the iterative deconvolution imaging condition according to claim 18, wherein if the deconvolution imaging objective function value does not meet a preset condition, the iterating the imaging result until the deconvolution imaging objective function value meets the preset condition, and generating a final iterative deconvolution multiple-wave imaging result based on an imaging result obtained after iteration comprises using:
a formula of the iterative deconvolution imaging condition:
$${R}_{i , j , k , l}^{n + 1} = \frac{{U}_{i , j , k , l} {\overline{D}}_{i , j , k , l} + α ( {R}_{i + 1 , j , k , l}^{n} + {R}_{i - 1 , j , k , l}^{n} ) + α ( {R}_{i , j + 1 , k , l}^{n} + {R}_{i , j - 1 , k , l}^{n} )}{{D}_{i , j , k , l} {\overline{D}}_{i , j , k , l} + 2 ( 3 α + β )} + \frac{α ( {R}_{i , j , k + 1 , l}^{n} + {R}_{i , j , k - 1 , l}^{n} ) + β ( {R}_{i , j , k + 1 , l}^{n} + {R}_{i , j , k - 1 , l}^{n} )}{{D}_{i , j , k , l} {\overline{D}}_{i , j , k , l} + 2 ( 3 α + β )} ;$$
where Rⁿ⁺¹ denotes an imaging result after an (n+1)-th iteration;
Rⁿ denotes an imaging result after an n-th iteration;
i, j, k and l denote spatial and frequency coordinates (x, y, z, ω) of the imaging result;
D̅ denotes a complex conjugate of the seismic wave forward-propagated wavefield.

20. The multiple-wave migration imaging method based on the iterative deconvolution imaging condition according to claim 19, wherein if the deconvolution imaging objective function value does not meet a preset condition, the iterating the imaging result until the deconvolution imaging objective function value meets the preset condition, and generating a final iterative deconvolution multiple-wave imaging result based on an imaging result obtained after iteration comprises:
recalculating the objective function value according to an imaging result Rⁿ⁺¹ after iteration, wherein the objective function value gradually approaches 0 during calculation; and
when the deconvolution imaging objective function value meets a preset condition, generate a final iterative deconvolution multiple-wave imaging result according to the imaging result after iteration.
